(19) United States
(12) Patent Application Publication
(10) Pub. No.: US 2026/0008246 A1
(43) Pub. Date: Jan. 8, 2026

(54) ROLLER TURN-UP MECHANISM AND MECHANICAL DRUM

(71) Applicants: MESNAC CO., LTD., Qingdao, Shandong (CN); QINGDAO MESNAC MACHINERY & ELECTRIC ENGINEERING CO., LTD., Qingdao, Shandong (CN)

(72) Inventors: Xingrui Li, Qingdao, Shandong (CN); Yihang Yu, Qingdao, Shandong (CN); Zhaolei Wang, Qingdao, Shandong (CN); Yu Yang, Qingdao, Shandong (CN); Jie Hu, Qingdao, Shandong (CN)

(21) Appl. No.: 18/875,738

(22) PCT Filed: Jun. 16, 2023
(86) PCT No.: PCT/CN2023/100830

§ 371 Date: Dec. 17, 2024

(30) Foreign Application Priority Data
Jun. 17, 2022 (CN) 202221537124.X

(51) Int. Cl. B29D 30/32

(52) U.S. Cl. CPC B29D 30/32; B29D 2030/3257

(57) ABSTRACT

A roller turn-up mechanism including a plurality of first turn-up structures is provided. The first turn-up structure includes: a roller assembly configured to roll a sidewall of a tire; a first drive rod drivingly connected to a roller assembly, and a first drive assembly connected to the first drive rod to move the roller assembly in a radial direction of the tire through the first drive rod; a support assembly connected to the first drive rod to support the sidewall of an outer side of the roller turn-up mechanism; and a second drive assembly connected to the support assembly to drive the roller assembly to press the tire through the support assembly; a second driving rod connected to the second drive assembly and further rotationally connected to the first driving rod; a third driving rod.

### TECHNICAL FIELD

The present disclosure relates to the technical field of rubber tires, and in particular to a roller turn-up mechanism and a mechanical drum.

### BACKGROUND

When the existing tires are turned-up built, a capsule drum is mainly used to turn up a sidewall of the tire. The sidewall is attached by inflating the capsule, thereby avoiding a problem of tire-side-surface indentation. However, the capsule drum has problems of cumbersome capsule replacement, high capsule cost, and poor tire-bead building quality compared with mechanical drums, resulting in a high tire defective rate and high cost. As for mechanical drums, it is difficult to control the pressure applied when rolling the sidewall, and it is easy to have quality problems such as wrinkles, which are less applicable.

### SUMMARY

A plurality of embodiments of the present disclosure provide a roller turn-up mechanism and a mechanical drum, so as to solve the problem of wrinkles easily occurring when the mechanical drum t rolls the sidewall in the prior ar.

According to an embodiment of the present disclosure, a roller turn-up mechanism is provided, which is arranged on a spindle assembly and includes a plurality of first turn-up structures arranged circumferentially around the spindle assembly, characterized in that the first turn-up structure includes: a roller assembly configured to roll a sidewall of a tire; a first drive assembly connected to the first drive rod to move the roller assembly in a radial direction of the tire through the first drive rod; a support assembly connected to the first drive rod to support the sidewall of an outer side of the roller turn-up mechanism; and a second drive assembly connected to the support assembly to drive the roller assembly to press the tire through the support assembly; where the roller assembly is arranged on the support assembly.

In a preferred embodiment of the present disclosure, the roller assembly is rotationally arranged on an end of the support assembly, wherein the end of the support assembly close to the roller assembly is rotationally connected to the first drive rod.

In a preferred embodiment of the present disclosure, the first turn-up structure further includes: a second drive rod being connected to the second drive assembly and being further rotationally connected to the first drive rod; a third drive rod, one end of the third drive rod being rotationally connected to an end of the support assembly away from the roller assembly, and the other end of the third drive rod being further rotationally connected to the second drive rod; where the second drive assembly drives the second drive rod to move to drive the first drive rod and the third drive rod to rotate respectively.

In a preferred embodiment of the present disclosure, the first turn-up structure further includes: a fourth drive rod connected to the first drive assembly and further rotationally connected to the first drive rod, wherein the first drive assembly drives the first drive rod to rotate through the fourth drive rod.

In a preferred embodiment of the present disclosure, the fourth drive rod is movably arranged along an axial direction of the spindle assembly, and the first drive assembly drives the fourth drive rod to move along the axial direction of the spindle assembly.

In a preferred embodiment of the present disclosure, the support assembly includes a plurality of support rods, and the plurality of support rods are arranged at intervals in a direction perpendicular to the sidewall to support the sidewall.

In a preferred embodiment of the present disclosure, the first turn-up structure further includes: a plurality of cylinders arranged on each of the support rods in a one-to-one correspondence, wherein the cylinders are rotationally sleeved on the support rods.

In a preferred embodiment of the present disclosure, the roller turn-up mechanism further includes: a second turn-up structure, wherein the first turn-up structure and the second turn-up structure respectively turn up and roll the sidewall, wherein the first turn-up structure is arranged on the spindle assembly, and the second turn-up structure is arranged on a side of the spindle assembly.

In a preferred embodiment of the present disclosure, the second turn-up structure includes: two suspension arms symmetrically arranged at intervals and configured to form a turn-up space between the two suspension arms; and a third drive assembly connected to the two suspension arms to simultaneously move the two suspension arms to roll the sidewalls on both sides of the tire.

According to another aspect of the present disclosure, a mechanical drum is provided, which includes: a spindle assembly and two roller turn-up mechanisms, where the two roller turn-up mechanisms are symmetrically arranged on the spindle assembly, and the roller turn-up mechanisms are the above-mentioned roller turn-up mechanisms.

The roller assembly using the technical solution of the present disclosure is arranged on the support assembly. According to an embodiment, the roller assembly includes a roller or a roller, and the roller is rotationally arranged at one end of the support assembly close to the sidewall, and the second drive assembly may directly press the sidewall by pushing the roller assembly; according to a second embodiment, the second drive assembly pushes the first drive rod, and the first drive rod is connected to one end of the support assembly close to the roller assembly, thereby pushing the roller assembly to press the sidewall; according to a third embodiment, the roller is rotationally arranged at one end of the support assembly close to the sidewall, one end of the support assembly close to the roller assembly is rotationally connected to the first drive rod, the second drive assembly is simultaneously connected to the first drive rod and the support assembly and applies pressure to the roller of the roller assembly through the first drive rod and the support assembly respectively so that the roller presses the sidewall.

### BRIEF DESCRIPTION OF DRAWINGS

The drawings in the description, which constitute a part of the present disclosure, are used to provide a further understanding of the present disclosure. The illustrative embodiments of the present disclosure and their descriptions are used to explain the present disclosure and do not constitute an improper limitation on the present disclosure. In the figures:

FIG. 1 is a schematic structural diagram of an embodiment of a mechanical drum according to the present disclosure.

FIG. 2 is a partial structural schematic diagram of an embodiment of the roller turn-up mechanism of the present disclosure.

The above figures include the following reference numerals:
10. Spindle assembly; 20. First turn-up structure; 201. Roller assembly; 21. First drive rod; 211. First drive assembly; 22. Second drive rod; 221. Second drive assembly; 23. Third drive rod; 24. Fourth drive rod; 25. Support assembly; 30. Second turn-up structure; 40. Lock ring structure; 50. Sidewall.

### DESCRIPTION OF EMBODIMENTS

It should be noted that, in the absence of conflict, the embodiments and features in the embodiments of the present disclosure may be combined with each other. The present disclosure will be described in detail below with reference to the accompanying drawings and in combination with embodiments.

In order to solve the problem of wrinkles easily occurring when the mechanical drum rolls the sidewall in the prior art, the present disclosure provides a roller turn-up mechanism and a mechanical drum.

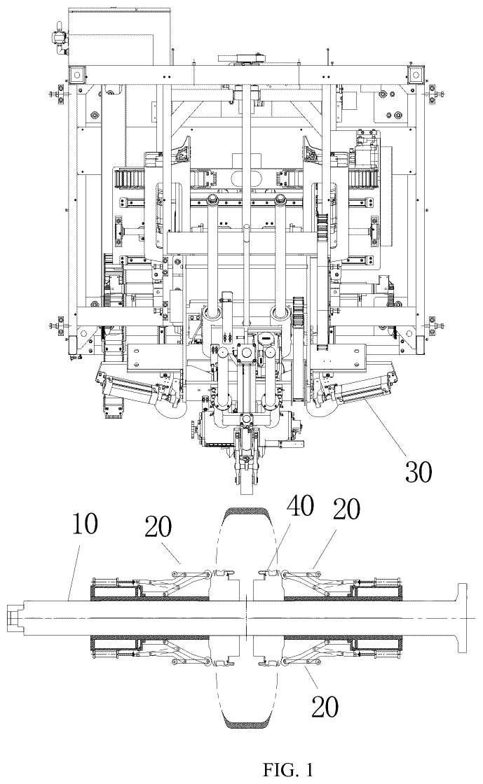

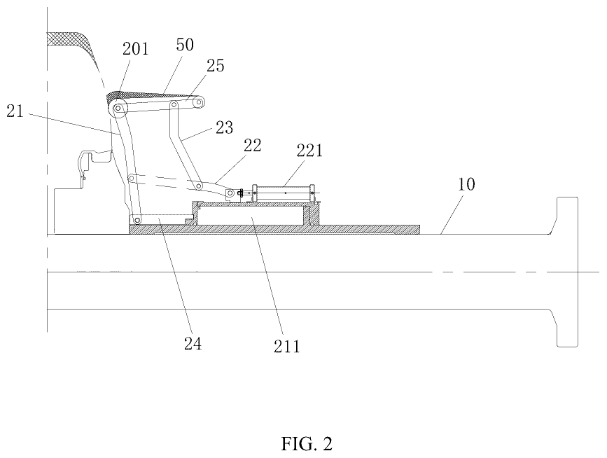

Referring to FIGS. 1 to 2, a roller turn-up mechanism of the present disclosure is arranged on a spindle assembly 10, and is mainly configured to turn up a carcass of the tire after a tire bead is installed, so that the sidewall is attached with a side surface of the carcass of the tire. The mechanical drum is used to replace the capsule turn-up, and the structure of the mechanical drum turn-up is improved to make the roller turn-up mechanism more stable, and the sidewall 50 can be attached on the carcass of the tire with high quality. The specific arrangement are as follows:

The roller turn-up mechanism of the present disclosure includes a plurality of first turn-up structures 20, the plurality of first turn-up structures 20 are arranged circumferentially around the spindle assembly 10. The first turn-up structure 20 includes: a roller assembly 201, a first drive rod 21, a first drive assembly 211, a support assembly and a second drive assembly 221. The roller assembly 201 is configured to directly abut against the sidewall 50 to roll the sidewall 50 of the tire, thereby pressing the sidewall 50 against the carcass of the tire; the first drive rod 21 is drivingly connected to the roller assembly 201, and the first drive assembly 211 is connected to the first drive rod 21 to move the roller assembly 201 in a radial direction of the tire by swinging the first drive rod 21; the second drive assembly 221 causes the roller assembly 201 to press the tire by pushing the first drive rod 21, so that the roller assembly 201 always rolls along the contour of the side surface of the carcass of the tire during the movement and maintains to abut against the carcass of the tire. At this time, the force condition of the structure is that the second drive assembly 221 directly pushes the first drive rod 21 to swing, thereby driving the upper roller assembly 201 to press the carcass of the tire. The above-mentioned structural arrangement reduces the force transmission route, reduces the force loss, and improves the efficiency of force transmission, so that the sidewall 50 attaches more stably.

In addition, the roller assembly 201 of the present disclosure is arranged on the support assembly 25. According to an embodiment, the roller assembly 201 includes a roller or a roller, and the roller is rotationally arranged at one end of the support assembly 25 close to the sidewall 50, and the second drive assembly 221 may directly press the sidewall 50 by pushing the roller assembly 201; according to a second embodiment, the second drive assembly 221 pushes the first drive rod 21, and the first drive rod 21 is connected to one end of the support assembly 25 close to the roller assembly 201, thereby pushing the roller assembly 201 to press the sidewall 50; according to a third embodiment, as shown in FIG. 2, the roller is rotationally arranged at one end of the support assembly 25 close to the sidewall 50, and one end of the support assembly 25 close to the roller assembly 201 is rotationally connected to the first drive rod 21, and the second drive assembly 221 is simultaneously connected to the first drive rod 21 and the support assembly 25 and applies pressure to the roller of the roller assembly 201 through the first drive rod 21 and the support assembly 25 respectively so that the roller presses the sidewall 50.

After being raised, the support assembly 25 is perpendicular to the sidewall 50 of the tire or is inclined upward at one end away from the tire, so that the sidewall 50 can be supported in a better shape and the sidewall 50 pressed by the roller on the roller assembly 201 can be effectively prevented from sticking to the carcass of the tire. After the turn-up rod returns, the part of the sidewall 50 away from the roller on the roller assembly 201 forms a groove near the tire after the sidewall 50 is turned up due to the shrinkage of the rubber. When the subsequent suspension arm is pressed, it may wrinkle when it presses the pit. For this reason, the present disclosure arranges the roller on the roller assembly 201 at one end of the support assembly 25 located at the sidewall 50, so that the roller assembly 201 and the support assembly 25 are at the same distance from the center of the tire in the radial direction of the tire. When rolling, the subsequent suspension arm will continue to roll at the position where the roller assembly 201 is rolled, and will not press wrinkles on the sidewall 50.

The first drive assembly 211 and the second drive assembly 221 are both driven by cylinders.

The first turn-up structure 20 further includes a second drive rod 22 and a third drive rod 23. The second drive rod 22 is connected to the second drive assembly 221, and one end of the second drive rod 22 is further rotationally connected to the first drive rod 21 to push the first drive rod 21 to swing; the other end of the third drive rod 23 is rotationally connected to an end of the support assembly 25 away from the roller assembly 201, and the other end of the third drive rod 23 is further rotationally connected to the second drive rod 22; where the second drive assembly 221 moves the second drive rod 22 to simultaneously rotate the first drive rod 21 and the third drive rod 23, and the first drive rod 21 and the third drive rod 23 rotate simultaneously to rise the upper support assembly 25 so as to support the unrolled sidewall 50.

In order to realize the movement of the roller assembly 201 along the side surface of the carcass of the tire, the first turn-up structure 20 of the present disclosure is further provided with a fourth drive rod 24, the fourth drive rod 24 is connected to the first drive assembly 211, and the fourth drive rod 24 is further rotationally connected to the first drive rod 21, where the first drive assembly 211 rotates the first drive rod 21 through the fourth drive rod 24, the first drive assembly 211 adopts a cylinder, the cylinder is arranged on the spindle assembly 10, and the fourth drive rod 24 is movably arranged along an axial direction of the spindle assembly 10. During operation, the cylinder pushes the fourth drive rod 24 to move along the axial direction of the spindle assembly 10, the other end of the fourth drive rod 24 is hinged to the end of the first drive rod 21, and the other end of the first drive rod 21 is abutted against the sidewall 50 through the roller assembly 201, and the fourth drive rod 24 moves horizontally to push the first drive rod 21 to swing, so that the roller assembly 201 is pressed on the sidewall 50 to slide, and the swinging movement form reduces the problem of the roller assembly 201 getting stuck when encountering pits or protrusions on the sidewall 50.

One end of the first drive rod 21 is connected to the support assembly 25, and the other end of the first drive rod 21 is hinged to the fourth drive rod 24, where the second drive rod 22 is hinged to the part of the first drive rod 21 located between the support assembly 25 and the fourth drive rod 24, and the roller assembly 201 is arranged at one end of the first drive rod 21 close to the support assembly 25 or the roller assembly 201 is arranged at one end of the support assembly 25 close to the sidewall 50.

In this embodiment, the connection positions of the fourth drive rod 24, the second drive rod 22 and the support assembly 25 with the first drive rod 21 are arranged such that the roller assembly 201 can smoothly and stably press the sidewall 50. Alternatively, one end of the second drive rod 22 is hinged to the first drive rod 21, and the other end of the second drive rod 22 is hinged to the second drive assembly 221, where the third drive rod 23 is hinged to the part of the second drive rod 22 located between the first drive rod 21 and the second drive assembly 221.

In order to support the unattached portion of the sidewall 50, the support assembly 25 of the present disclosure is provided with a plurality of support rods, and the plurality of support rods are arranged at intervals in a direction perpendicular to the sidewall 50 to support the drooping sidewall 50 as much as possible, where the first turn-up structure 20 further includes a plurality of roller barrels, and the plurality of roller barrels are arranged in a one-to-one correspondence on each support rod, where the roller barrels are rotationally sleeved on the support rods so that the sidewall 50 can slide.

In order to better enable the roller assembly 201 to roll the sidewall 50 smoothly, according to the present disclosure, the roller assembly 201 is rotationally arranged on the first drive rod 21 or the support assembly 25. Alternatively, the roller assembly 201 includes an annular roller, and the roller is arranged at the end of the first drive rod 21, or the roller is sleeved on the support rod of the support assembly 25 close to one end of the sidewall 50.

In addition, in order to ensure the attaching quality between the sidewall and the side surface of the carcass of the tire, the turn-up mechanism of connecting rod according to the present disclosure adopts a first turn-up structure and a second turn-up structure to roll the sidewall twice. In the first time, the first turn-up structure is configured to roll the sidewall of the tire, and the first rolling is also performed from the inside to the outside. After the first rolling is completed, the second turn-up structure is configured to roll the sidewall of the tire for a second time, and the second rolling is also performed from the inside to the outside.

The second turn-up structure 30 includes two suspension arms and a third drive assembly. The two suspension arms are symmetrically and arranged at intervals. The two suspension arms may be arranged close to or far away from each other. A turn-up space is formed between the two suspension arms. When the suspension arms are close to each other, the ends of the suspension arms are attached to the sidewall 50, and the sidewall 50 is attached to the side surface of a carcass of the tire by rolling. The third drive assembly is connected to both suspension arms. The third drive assembly uses a cylinder to simultaneously move the two suspension arms and roll the sidewalls 50 on both sides of the tire.

The present disclosure further provides a mechanical drum, which includes a spindle assembly 10 and two roller turn-up mechanisms, the two roller turn-up mechanisms are symmetrically arranged on the spindle assembly 10, and the two turn-up structures roll the sidewalls on both sides of the tire respectively, where the roller turn-up mechanism is the above-mentioned roller turn-up mechanism. The mechanical drum abandons the existing capsule turn-up form, and forms rolling on the sidewall 50 through the cylinder, connecting rod mechanism and roller assembly 201, which extends a service life and saves costs.

In addition, the mechanical drum of the present disclosure further includes a locking ring structure 40. There are two locking ring structures 40 which are symmetrically arranged on the spindle assembly and located between the two roller turn-up mechanisms, and are configured to lock the tire bead, thereby fixing the carcass of the tire.

The above embodiments are only preferred embodiments of the present disclosure and are not intended to limit the present disclosure. For those skilled in the art, the present disclosure may have various modifications and changes. Any modifications, equivalent substitutions, improvements, etc. made within the spirit and principles of the present disclosure should be included in the protection scope of the present disclosure.

1. A roller turn-up mechanism, which is arranged on a spindle assembly (10) and comprises a plurality of first turn-up structures (20) arranged circumferentially around the spindle assembly (10), characterized in that the first turn-up structure (20) comprises:
a roller assembly (201) configured to roll a sidewall (50) of a tire;
a first drive rod (21) drivingly connected to the roller assembly (201),
a first drive assembly (211) connected to the first drive rod (21) to move the roller assembly (201) in a radial direction of the tire through the first drive rod (21);
a support assembly (25) connected to the first drive rod (21) to support the sidewall (50) of an outer side of the roller turn-up mechanism; and
a second drive assembly (221) connected to the support assembly (25) to drive the roller assembly (201) to press the tire through the support assembly (25);
wherein the roller assembly (201) is arranged on the support assembly (25),
the roller assembly (201) is rotationally arranged on an end of the support assembly (25), wherein the end of the support assembly (25) close to the roller assembly (201) is rotationally connected to the first driving rod (21);
the first turn-up structure (20) further comprises:
a second driving rod (22) connected to the second drive assembly (221) and further rotationally connected to the first driving rod (21);
a third driving rod (23), wherein an end of the third driving rod (23) is rotationally connected to an end of the supporting assembly (25) away from the roller assembly (201), and the other end of the third driving rod (23) is rotationally connected to the second driving rod (22);
wherein the second driving assembly (221) drives the second driving rod (22) to rotate the first driving rod (21) and the third driving rod (23) respectively.

2. The roller turn-up mechanism of claim 1, characterized in that the first turn-up structure (20) further comprises:
a fourth driving rod (24) connected to the first driving assembly (221) and further rotationally connected to the first driving rod (21), wherein the first driving assembly (221) drives the first driving rod (24) to rotate through the fourth driving rod (24).

3. The roller turn-up mechanism of claim 2, characterized in that the fourth driving rod (24) is movably arranged along an axial direction of the spindle assembly (10), and the first driving assembly (211) drives the fourth driving rod (24) to move along the axial direction of the spindle assembly (10).

4. The roller turn-up mechanism of claim 1, characterized in that the support assembly (25) comprises a plurality of support rods, and the plurality of support rods are arranged at intervals in a direction perpendicular to the sidewall (50) to support the sidewall (50).

5. The roller turn-up mechanism of claim 4, characterized in that the first turn-up structure (20) further comprises:
a plurality of cylinders arranged on each of the supporting rods in a one-to-one correspondence, wherein the cylinders are rotationally sleeved on the supporting rods.

6. The roller turn-up mechanism of claim 1, characterized in that the roller turn-up mechanism further comprises: a second turn-up structure (30), wherein the first turn-up structure (20) and the second turn-up structure (30) respectively turn up and roll the sidewall (50), wherein the first turn-up structure (20) is arranged on the spindle assembly (10), and the second turn-up structure (30) is arranged on a side of the spindle assembly (10).

7. The roller turn-up mechanism of claim 6, characterized in that the second turn-up structure (30) comprises:
two suspension arms symmetrically arranged at intervals and configured to form a turn-up space between the two suspension arms; and
a third drive assembly connected to the two suspension arms to simultaneously move the two suspension arms to roll the sidewalls on both sides of the tire.

8. A mechanical drum, comprising: a spindle assembly (10) and two roller turn-up mechanisms, wherein the two roller turn-up mechanisms are symmetrically arranged on the spindle assembly (10), characterized in that the roller turn-up mechanisms are the roller turn-up mechanisms of claim 1.

9. The mechanical drum of claim 8, characterized in that the first turn-up structure (20) further comprises:
a fourth driving rod (24) connected to the first driving assembly (221) and further rotationally connected to the first driving rod (21), wherein the first driving assembly (221) drives the first driving rod (24) to rotate through the fourth driving rod (24).

10. The mechanical drum of claim 9, characterized in that the fourth driving rod (24) is movably arranged along an axial direction of the spindle assembly (10), and the first driving assembly (211) drives the fourth driving rod (24) to move along the axial direction of the spindle assembly (10).

11. The mechanical drum of claim 8, characterized in that the support assembly (25) comprises a plurality of support rods, and the plurality of support rods are arranged at intervals in a direction perpendicular to the sidewall (50) to support the sidewall (50).

12. The mechanical drum of claim 11, characterized in that the first turn-up structure (20) further comprises:
a plurality of cylinders arranged on each of the supporting rods in a one-to-one correspondence, wherein the cylinders are rotationally sleeved on the supporting rods.

13. The mechanical drum of claim 8, characterized in that the roller turn-up mechanism further comprises: a second turn-up structure (30), wherein the first turn-up structure (20) and the second turn-up structure (30) respectively turn up and roll the sidewall (50), wherein the first turn-up structure (20) is arranged on the spindle assembly (10), and the second turn-up structure (30) is arranged on a side of the spindle assembly (10).

14. The mechanical drum of claim 13, characterized in that the second turn-up structure (30) comprises:
two suspension arms symmetrically arranged at intervals and configured to form a turn-up space between the two suspension arms; and
a third drive assembly connected to the two suspension arms to simultaneously move the two suspension arms to roll the sidewalls on both sides of the tire.
